(19) United States
(12) Patent Application Publication
(10) Pub. No.: US 2008/0257777 A1
(43) Pub. Date: Oct. 23, 2008

(54) Vertically Oriented Labels for Medicine Container

(75) Inventors: David A. Miceli, Sparta, TN (US); Joseph A. Miceli, Sparta, TN (US)

Correspondence Address: WADDEY & PATTERSON, P.C., 1600 DIVISION STREET, SUITE 500, NASHVILLE, TN, 37203, US

(73) Assignee: TRI STATE DISTRIBUTION, INC, Sparta, TN (US)

(21) Appl. No.: 12/106,424

(22) Filed: Apr. 21, 2008

Related U.S. Application Data
(60) Provisional application No. 60/912,723, filed on Apr. 19, 2007.

(51) Int. Cl. B65D 83/04; G09F 3/00

(52) U.S. Cl. 206/534; 206/540; 40/310

(57) ABSTRACT

A prescription storing and dispensing device including a label having alphanumeric indicia that is orientated to be substantially parallel with the axis of the container. The label can include the patient's name, name of the medicine, and optionally other medical information positioned in a substantially vertical manner with respect to the container.

### CROSS-REFERENCES TO RELATED APPLICATIONS

This application is a non-Provisional application which claims benefit of co-pending U.S. Patent Application Ser. No. 60/912,723 filed Apr. 19, 2007, entitled “Vertically Oriented Labels for Medicine Container” which is hereby incorporated by reference in its entirety.

A portion of the disclosure of this patent document contains material that is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

All patents and publications described or discussed herein are hereby incorporated by reference in their entireties.

### BACKGROUND OF THE INVENTION

The present invention relates generally to a label that may be apply to a vial, bottle, or other container having a closure, which may be described as a cap or a top. The combination of the container and closure can be described as a closure container assembly or system wherein the label is specifically oriented on the assembly to facilitate reading of the information contained thereon. The closure and container assembly are designed to store and dispense materials, particularly prescriptions.

There are many types of closure systems described in the art. For example there are closures that are child resistant, closures that are non-child resistant, and closures that are convertible from child resistant to non-child resistant, from non-child resistant to child resistant, or convertible between the two modes multiple times. Most of the technology in this field has been directed at improving the container and/or closure, or the interface between the container and closure.

Very little advancement has been directed towards the labeling or information provided with the prescriptions or the labeling attached to the container. Typically this labeling is oriented such that the lines of alphanumeric characters are substantially perpendicular to the axis of a container. This poses a problem in the reading of the information contained on the label by a user of the container.

For example, typically the containers have small diameters such that words having anything but more than a few letters require the holder of the container to rotate the container about its axis in order to be able to read the information contained thereon. This is especially cumbersome given the multiple characters and/or letters that comprise most medicines, which can be upwards of 15-20 letters long.

Additionally, any warnings on the labels in the form of sentences or small paragraphs require multiple turns and/or rotations of the container in order for a user to be able to read that information. This can be annoying and troublesome to the user and does not facilitate an ease of information transfer from a label to the user of a container.

In light of the foregoing there is a need for a label that is oriented such that the indicia positioned thereon is substantially parallel with the axis of the container such that a reader of that information can readily read, ascertain and comprehend the information contained on that label with minimal manipulation of the container during that reading.

### BRIEF SUMMARY OF THE INVENTION

The present invention is directed to a label adapted for use in a closure and container system that can substantially obviate one or more of the problems due to limitations and disadvantages of the related art. Additional features and advantages of the invention will be set forth in the description which follows, and in part will be apparent from the description, or may be learned by practice of the invention. The objects and other advantages of the invention can be further realized and attained by those features of the invention particularly pointed out in the description and claims hereof as well as the appended drawings.

The present invention is directed to a pharmacy label that is oriented substantially parallel with the axis of a closure to which it is to be affixed.

The label is used in connection with a prescription storing and dispensing device having a closure and container. The prescription storing and dispensing device includes a label having alphanumeric indicia that is orientated to be substantially parallel with the axis of the container. More specifically, the label can include the patient's name, name of the medicine, and optionally other medical information positioned in a substantially vertical manner with respect to the container.

The container includes a bottom and a neck having an opening and one or more engaging devices positioned and shaped to interact with corresponding engaging devices on the closure. The axis of the container runs through the opening and bottom of the container. The label includes indicia oriented along lines substantially parallel with the axis of a container.

The label can include a width that spans substantially from the bottom to the neck of the container. The indicia positioned on the label can also substantially traverse this width of the label. As such more information can be placed on a label than conventionally possible and the orientation of the letters and words are such that reading of a line of the indicia requires little to no rotational movement of the container.

It is therefore a general object of the present invention to provide a label having indicia that is orientated for positioning on a prescriptions container such that the indicia is substantially parallel with the axis of the container.

Another object of the present invention is to provide a label having alphanumeric indicia positioned substantially parallel with the longitudinal axis of a medical vial or medical bottle.

Still another object of the present invention is to provide a prescription system having indicia that are substantially aligned with the vertical axis of the prescription system.

Other and further objects, features and advantages of the present invention will be readily apparent to those skilled in the art upon reading of the following disclosure when taken in conjunction with the accompanying drawings.

### BRIEF DESCRIPTION OF THE SEVERAL VIEWS OF THE DRAWINGS

FIG. 1 is a front perspective view of the conventional positioning of indicia substantially perpendicular to the axis of a prescription container.

FIG. 2 is an example of a container and label made in accordance with the current disclosure.

FIG. 3 shows a front view of a label made in accordance with the current invention positioned on a container with an associated closure.

FIG. 4 shows a front view of a label made in accordance with the current disclosure positioned on a container with an associated closure.

FIG. 5 shows a perspective view of the label and container shown in FIG. 4.

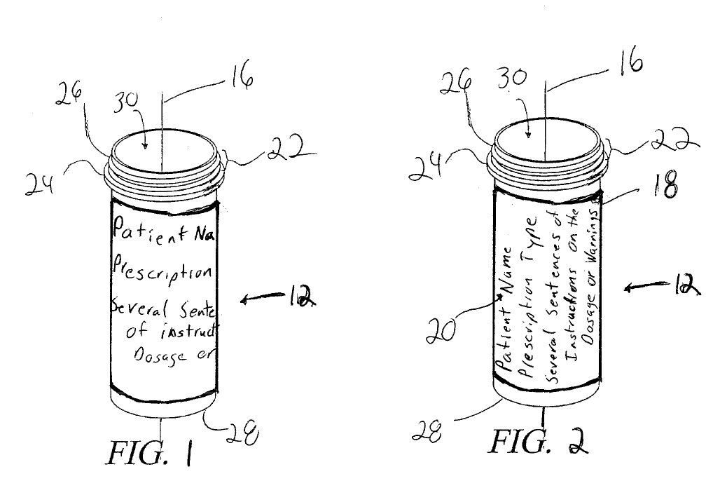

### DETAILED DESCRIPTION OF THE INVENTION

FIG. 1 shows a conventional label positioned on a container. In this conventional positioning, the indicia are typically positioned in a horizontal direction, or substantially perpendicular to the axis 16 of the container 12, even when viewed in a perspective view, requires some rotation of the container about the axis to normally complete the reading of a given line of information of that conventional label. As seen in FIG. 1, the patient name, prescription type and several sentences of instructions on the dosage or warnings cannot be completely read.

In contrast, a label 18 having indicia 20 oriented in a vertical nature facilitates the readability of the indicia 20 on the label 18. The label 18 has indicia 20 position substantially parallel to the axis 16 of the container 12 for the prescription system 10. The label 18 includes the indicia 20, preferably comprising alphanumeric characters, positioned along the lines on the label 18 substantially parallel with the axis 16 of the container 12.

The container 12 includes a neck 22 having a rim 24 and an engaging device 26 designed to interact with the closure 14 to secure the prescriptions contained on the inside 30 of the container 12. The closure 14 can include an engaging mechanism designed to interact with the engaging device 26 of the container 12. Suitable engaging devices or engaging mechanism can include one or more beads, threads, lugs or the like as is known in the art.

The bottom 28 of the container 12 and rim 24 typically provide enough space to position the label 18 there between. The label 18 can include a length that substantially spans the distance between the neck 22 and bottom 28.

This orientation of the alphanumeric characters allows a longer reading of sequentially positioned alphanumeric characters that comprise the words and information normally printed on a prescription label. This allows a user of the container 12 to read the label 18 with a reduced amount of rotation of the container 12 about the axis 16. This facilitates a better transfer of information to the user and thus providing a better product to that user in a safer manner.

This orientation of the alphanumeric characters 20 allows for more information to be positioned on label 18 thereby better explaining information to the user. For example, detailed information can be provided on dosages, warnings, intake information, and other needed and/or preferred information provided with the prescriptions.

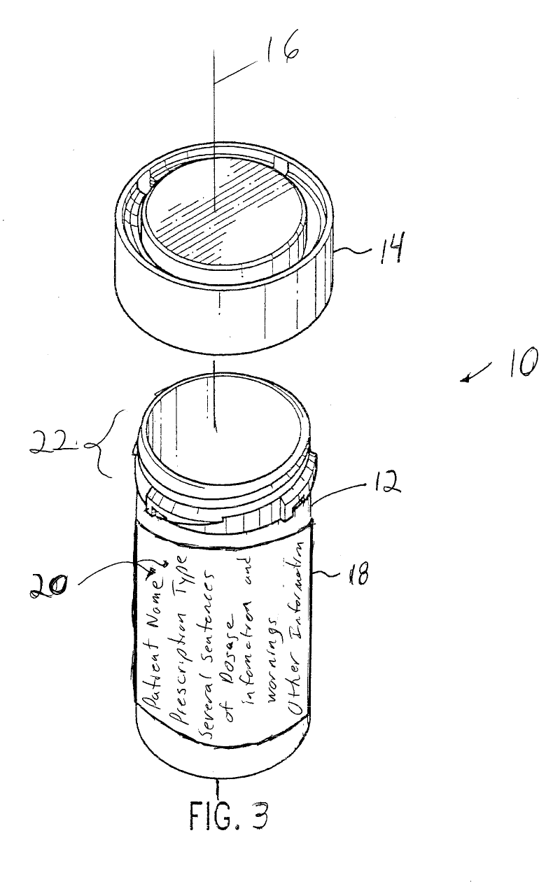

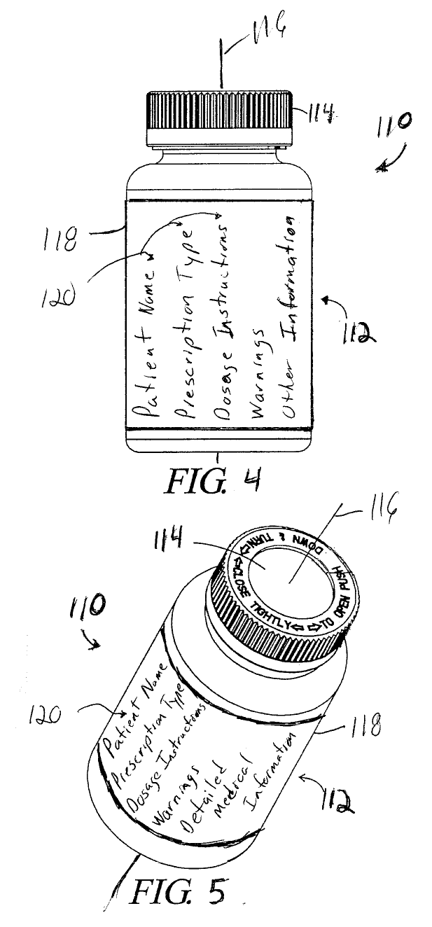

FIG. 3 shows an alternate embodiment of the container having a different engaging device for engagement with the closure. The label 18 can be configured substantially the same as described above. FIGS. 4 and 5 disclose yet another prescription system 110 having an alternate closure 114 and container 112. This label 118 can be larger in nature and still have alphanumeric characters positioned in a substantially vertical orientation with respect to the axis 116 of the container 112.

Thus, although there have been described particular embodiments of the present invention of a new and useful Vertically Oriented Labels for Medicine Container, it is not intended that such references be construed as limitations upon the scope of this invention except as set forth in the following claims.

What is claimed is:

1. A prescription container system for holding and dispensing a prescription to a user of the prescription container system, the prescription container system comprising:
a container shaped to hold a prescription and including a longitudinal axis;
a closure shaped to engage the container and form a seal with the container to secure the prescription; and
a label having indicia positioned along lines substantially parallel with respect to the longitudinal axis of the container.

2. The prescription container system of claim 1, wherein the container includes a neck separated a distance from a bottom and the label substantially spans the distance between the neck and bottom.

3. The prescription container system of claim 2, wherein the container includes a circumference and the label substantially spans the circumference.

4. The prescription container system of claim 2, wherein the rotation of the container about the longitudinal axis rotates the indicia about the axis.

5. The prescription container system of claim 2, wherein the indicia includes alphanumeric characters complied into words and the alphanumeric characters are sequentially positioned parallel to the longitudinal axis of the container.

6. The prescription container system of claim 5, wherein the indicia includes the user's name, the name of the prescription contained in the container, and optionally other medical information.

7. The prescription container system of claim 1, wherein the container includes a circumference and the label substantially spans the circumference.

8. The prescription container system of claim 1, wherein the indicia includes alphanumeric characters complied into words and the alphanumeric characters are sequentially positioned parallel to the longitudinal axis of the container.

9. The prescription container system of claim 8, wherein the alphanumeric characters that comprise the words relay information normally printed on a prescription label.

10. The prescription container system of claim 1, wherein the indicia includes the user's name, the name of the prescription contained in the container, and optionally other medical information.

11. A prescription container system for holding and dispensing a prescription to a user of the prescription container system, the prescription container system comprising:
a container shaped to hold a prescription and including a longitudinal axis, a circumference, a neck, a bottom, an open end, and a container engaging device;
a closure including an engaging mechanism designed to engage the container engaging device to close the open end shaped and form a seal with the container to secure the prescription; and
a label having indicia positioned on the circumference of the container along lines substantially parallel with respect to the longitudinal axis of the container.

12. The prescription container system of claim 11, wherein the neck is separated a distance from the bottom and the label substantially spans the distance between the neck and bottom and the circumference of the container.

13. The prescription container system of claim 11, wherein the indicia includes the user's name, the name of the prescription contained in the container, and optionally other medical information.

14. The prescription container system of claim 11, wherein the indicia includes alphanumeric characters complied into words and the alphanumeric characters are sequentially positioned parallel to the longitudinal axis of the container.

15. The prescription container system of claim 14, wherein the alphanumeric characters that comprise the words relay information normally printed on a prescription label.

16. A prescription container system for holding and dispensing a prescription to a user of the prescription container system, the prescription container system comprising:
a container shaped to hold a prescription and including a longitudinal axis, a circumference, a neck, a bottom, an open end, and a container engaging device;
a closure including an engaging mechanism designed to engage the container engaging device to close the open end and form a seal with the container to secure the prescription; and
a label having indicia positioned on the circumference of the container along lines substantially parallel with respect to the longitudinal axis of the container, the indicia including alphanumeric characters complied into words and the alphanumeric characters and words are sequentially positioned substantially parallel to the longitudinal axis of the container.

17. The prescription container system of claim 16, wherein the alphanumeric characters that comprise the words relay information normally printed on a prescription label

18. The prescription container system of claim 16, wherein the neck is separated a distance from the bottom and the label substantially spans the distance between the neck and bottom and the circumference of the container.

19. The prescription container system of claim 16, wherein the indicia includes the user's name, the name of the prescription contained in the container, and optionally other medical information.
